(19) United States
(12) Patent Application Publication
(10) Pub. No.: US 2015/0321772 A1
(43) Pub. Date: Nov. 12, 2015

(54) Pre Conditioned Air Duct Reel Apparatus With Air Inlet Polymer Rotary Swivel

(71) Applicant: Dale W. Taylor, Hamilton, IN (US)

(72) Inventor: Dale W. Taylor, Hamilton, IN (US)

(21) Appl. No.: 14/803,090

(22) Filed: Jul. 19, 2015

Related U.S. Application Data
(63) Continuation-in-part of application No. 13/385,991, filed on Mar. 19, 2012.

(51) Int. Cl. B64F 1/36; B65H 75/40

(52) U.S. Cl. CPC B64F 1/364; B65H 75/403

(57) ABSTRACT

The pre conditioned air duct storage and deployment apparatus includes a plenum reel assembly having an air outlet means for connection to one end of the ducting, a frame rotatably supporting the plenum reel assembly comprising a reversible drive motor supported by the frame having an output drive shaft rotatably driving the plenum reel assembly in a first direction to retract the ducting and a second direction to deploy the ducting, a polymer rotary swivel assembly having a first diameter fixedly supported by the frame and having a second diameter fixedly attached and rotatably supporting the plenum reel assembly about an axis coextensive with the drive shaft axis. The frame and plenum reel assembly has an opening for means of air transference through the polymer rotary swivel assembly and the fixed portion of the polymer rotary swivel assembly has connecting means to an external pre conditioned air source.

### CROSS-REFERENCE TO RELATED APPLICATIONS

This application is a continuation-in-part of my prior application Ser. No. 13/385,991, filed Mar. 19, 2012.

### FIELD OF THE INVENTION

This invention relates to a powered reel apparatus for storage and deployment of duct for the supply of pre conditioned air for the heating and cooling of the interior of an aircraft while parked at an airport.

### BACKGROUND OF THE INVENTION

Commercial aircraft are equipped with an auxiliary power unit, or APU, to supply electrical power while the aircraft is parked on the ground and the engines are not running. A function of the APU is to power the aircraft on-board air conditioning system, however, the APU is a source of both high noise and also high carbon emissions. Recently most airports have come under the directive of regulations targeting a reduction in noise and also a reduction of the carbon pollution, and as a result, it is now required to shut down the aircraft engines and the APU and to supply pre conditioned air from an external source to aircraft parked at a terminal during the unloading and loading interval.

These pre conditioned air sources can be portable units mounted to a trailer or integrated to a vehicle platform, or stationary mounted units attached to the jet-bridge or terminal building. If the unit is portable it is simply driven to close proximity of the aircraft and a short duct is coupled between the portable air source and the aircraft inlet to convey the pre conditioned air. If the unit is stationary, however, then the problem of conveying the pre conditioned air to the aircraft is not so easily solved.

In U.S. Patent to Anderson et al, U.S. Pat. No. 3,399,545, there is disclosed a longitudinally expandable duct system that is mounted to the underside of a telescoping passenger loading bridge. The position of two points of the duct is fixed relative to two moveable sections, preferably the end sections, of the bridge. Thus the bridge and the duct are integrated in a single unit, both expanding together for use, and contracting together for storage. A supporting cable extends through the interior of the duct along the top surface thereof between the two relatively fixed points. Preferably the cable is fastened on one end, and the other end is wound on a reel maintaining a substantially constant tension on the supporting cable.

In U.S. Patent to Krzak, U.S. Pat. No. 4,357,860, there is disclosed a telescoping conduit for directing air at moderate pressures to a waiting aircraft along a telescoping bridge. The telescoping conduit includes a number of telescoping tubes suspended beneath the segments of a telescoping bridge. The tubes are coaxially supported below the bridge walkway by adjustable brackets, and one tube is mounted to each bridge segment. This means of suspension allows the tubes to telescopically extend and retract, or nest, to a maximum degree while providing support for the tubes at each end. The tubes are sealed typically with an O-ring at one end of each tube. The sealing portion of the tube, around which the O-rings are seated, is made of a somewhat flexible material which acts as a bearing and accommodates slight misalignment. A roller cage acts to center the nesting tubes so that a wiper seal between the tubes does not become permanently deformed.

The aforementioned two patents disclose an apparatus meant to convey the pre conditioned air duct to the end of the passenger bridge, however, the air inlet connector on the aircraft may be a distance of up to 100 feet away. And a means of deploying and storage of the duct is not yet solved.

As can be expected pre conditioned air duct can be rather large to accommodate the necessary airflow to control the internal environment of a large aircraft. For example, these hoses can have an inner diameter on the order of 8 inches to 16 inches. It can be appreciated that these ducts, due to their diameter and their length, can be quite heavy, and weigh in excess of 75 pounds. Operators must move these heavy ducts across the surface of the airport tarmac and fold them up to store them between aircraft departure and arrival of the next aircraft.

Referring to U.S. Patents to Bombardi et al, U.S. Pat. No. 6,776,705, U.S. Pat. No. 6,821,201, and U.S. Pat. No. 6,834,668, there is disclosed an apparatus for supplying conditioned air for heating and cooling to an aircraft. The apparatus has a container having a length defined by a first end and a second end. A flexible hose is provided within the container and a retractor may engage the hose and pull the hose from the container. The container may deliver the hose to the aircraft via the retractor. In addition, the retractor may also retract the hose into the container when the hose is not needed. The retractor may be released from the hose and the container, allowing the hose to be pulled manually from the container.

The Bombardi patents disclose pre conditioned air systems that are mounted to the passenger bridge and deploys the amount of hose required to suit the length of a particular aircraft, however, the system is technically complex with many moving parts and drive belts that can wear and break. Additionally, these types of systems are relatively expensive.

Other commercial devices are available to provide storage to the pre conditioned air duct between the departure of one aircraft and the arrival of the next. These types of electrically driven storage and deployment devices consist of chain driven plenum spools that utilize bicycle type chain, sprocket gears, and pinion gears connected to a motor for the drive system. End of travel limit switches are provided to stop the drive system when the duct is fully deployed or fully retracted and these limit switches are mechanically actuated via additional chains, sprockets, and an acme screw device. Air inlet rotary swivels are manufactured from metal alloys such as bronze which require precision machining of the inner and outer bearing race to allow rotation of the plenum spool, and require periodic greasing to reduce wear and prevent seizing of the two races together which may prevent further rotation of the plenum spool. While comparatively less expensive than the Bombardi style systems, these types of systems are maintenance intensive and care has to be taken to grease the swivel, and chain and drive systems regularly, and also adjust the chain tension due to the chain stretching over time.

A need, therefore, exists over the prior art, for a relatively inexpensive, low maintenance, and easily configurable storage and deployment system for duct used in the supply of pre conditioned air for the heating and/or cooling of the interior of commercial aircraft while parked at the airport terminal.

### SUMMARY OF THE INVENTION

The pre conditioned air duct reel apparatus includes a mounting frame rotatably supporting a plenum reel assembly comprising a first side frame mounting an electric reversible gear drive assembly, the plenum reel assembly first end drivenly connected to the gear drive shaft. The axially opposite, second side frame mounts an air inlet polymer rotary swivel mechanism having a stationary external race that is fixedly mounted to the second side frame about an air inlet opening, the air inlet polymer rotary swivel mechanism having a rotary internal race fixedly mounted to the plenum reel assembly second end about an opening corresponding to the internal diameter of the air inlet polymer rotary swivel internal race. The air inlet polymer rotary swivel mechanism having an internal race rotatably engaged within the stationary external race by a plurality of polymer bearing rods circumferentially placed in a plurality of corresponding circumferential grooves in the internal race, and an external race having an inwardly extending circumferential spline axially engaged between equally spaced apart polymer bearing rods, the polymer bearing rods being disposed between the inwardly facing diameter of the external race and the outwardly facing diameter of the internal race. Adjustable rotary limit switch cams are provided to control limit switches to de-energize the reversible drive motor at the limit of travel for the duct deployment or retraction to prevent over winding or under winding of the duct.

Additional features, aspects, and advantages of the present invention will become better understood when the following detailed description is read with references to the accompanying drawings in which like characters represent like parts throughout the drawings.

### BRIEF DESCRIPTION OF THE DRAWINGS

FIG. 1 illustrates a perspective view of an aircraft connected via a duct to a pre conditioned air storage and deployment reel apparatus according to an embodiment of the present invention;

FIG. 2 illustrates a perspective view of the front gear drive side of an embodiment of the reel apparatus shown in FIG. 1;

FIG. 3 illustrates a perspective view of the front air inlet side thereof;

FIG. 4 illustrates a front elevation view thereof;

FIG. 5 illustrates a rear elevation view thereof;

FIG. 6 illustrates a right side elevation view thereof;

FIG. 7 illustrates a left side elevation view thereof;

FIG. 8 illustrates a top plan view thereof;

FIG. 9 illustrates a bottom plan view thereof;

FIG. 10 illustrates a cross-sectional view of an embodiment of the present invention taken along line 10-10 of FIG. 7;

FIG. 11 illustrates a cross sectional view of an embodiment of the present invention taken along line 11-11 of FIG. 8;

FIG. 12 illustrates a side elevation view of an embodiment of the air inlet polymer rotary swivel of the present invention;

FIG. 13 illustrates a front elevation view of the air inlet polymer rotary swivel thereof;

FIG. 14 illustrates a cross sectional view of an embodiment of the air inlet polymer rotary swivel taken along line 14-14 of FIG. 13; and

FIG. 15 illustrates axial misalignment of the internal race with respect to the external race of an embodiment of the air inlet polymer rotary swivel of FIG. 14.

### DRAWINGS—REFERENCE NUMERALS

1 Aircraft

3 Duct Reel Apparatus

5 Pre Conditioned Air Ducting

7 Aircraft Inlet

9 Duct Clamp

10 Frame Assembly

11 Upper Frame

11A Side Frame

11B Side Frame

12 Plenum Reel Assembly

13A Side Flange

13B Side Flange

14 Air Duct Outlet Adaptor

16 Air Duct Inlet Adaptor

18 Plenum Reel Outlet Flange

20 Plenum Reel Wrapper

21 Gear Drive Assembly

22 Gear Drive Bearing

24 Gear Drive Housing

26 Drive Shaft

28 Gear Drive Hollow Shaft

30 Drive Shaft Key

32 Drive Motor

34 Limit Switch Cover

36 Gear Drive Mount Bracket

38 Limit Switch Rotary Shaft

40 Limit Switch Cam

42 Limit Switch

44 Limit Switch Mount

46 Drive Shaft Hub

47 Air Inlet

48 Air Inlet Polymer Rotary Swivel Assembly

50 External Race

50A External Inner Race

50B External Outer Race

52 Internal Race

52A Internal Inner Race

52B Internal Outer Race

53 External Race Spline

54 Internal Race Groove

55 Axial Misalignment Angle

60 Polymer Bearing Rod

70 Worm Gear

72 Motor Shaft

78 Inner Race Bolt

80 Inner Race Nut

82 Outer Race Bolt

84 Outer Race Nut

86 Hub Bolt

88 Mount Bolt

### DETAILED DESCRIPTION OF THE INVENTION

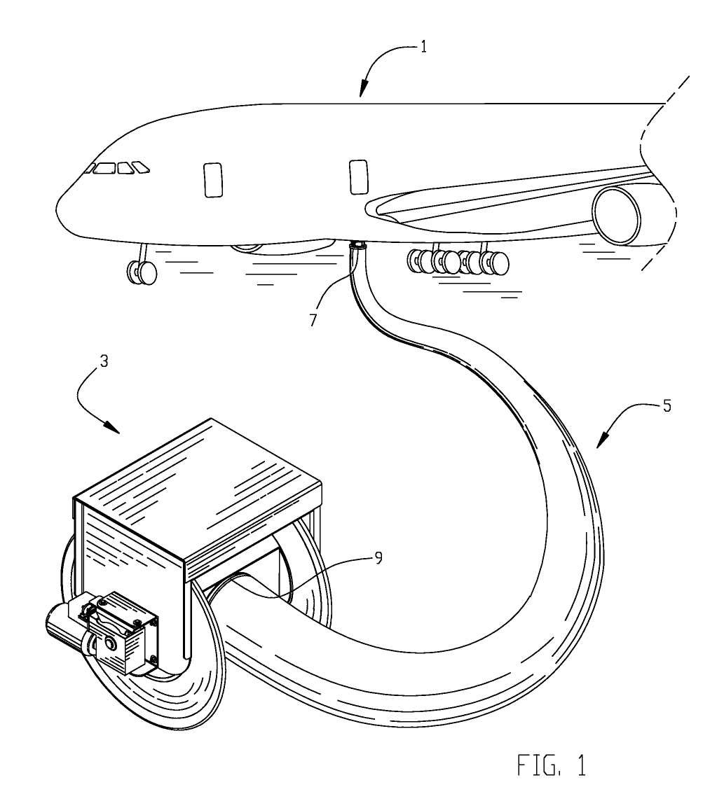

Referring generally to FIG. 1, an aircraft designated by the reference numeral 1, is illustrated in its parked position while the pre conditioned air ducting 5 is connected at a second end to aircraft air conditioning inlet 7, the first end being connected to duct reel apparatus 3 by duct clamp 9. While FIG. 1 illustrates pre conditioned air ducting 5 in the context of supplying conditioned air to an aircraft 1, it should be appreciated by one skilled in the art that pre conditioned air ducting 5 may be used in various other settings, such as mining, construction, or reversing the flow of air as in an exhaust application.

It should be appreciated by one skilled in the art that pre conditioned air ducting 5 is generally constructed of a heavy duty fabric material and will be flat when not being pressurized by the pre conditioned air to be supplied to aircraft 1. Pre conditioned air ducting 5 may be configured in any length required in order to reach air conditioning inlet 7, and duct reel apparatus 3 sized accordingly to store this required length. Duct reel apparatus 3 is configured to connect to a pre conditioned air delivery system and may be attached to a passenger bridge or to a fixed location, such as a terminal building, or mounted to a mobile cart, or vehicle. Pre conditioned air duct 5 must be disconnected at air inlet 7 from aircraft 1 and retracted and stored on duct reel apparatus 3 when aircraft 1 is in motion, such as when it taxis to and from a terminal. When aircraft 1 is parked, pre conditioned air ducting 5 is deployed from the duct reel apparatus 3 and connected to the aircraft 1 at aircraft inlet 7 to alleviate the need for the use of the air conditioning system of aircraft 1 itself.

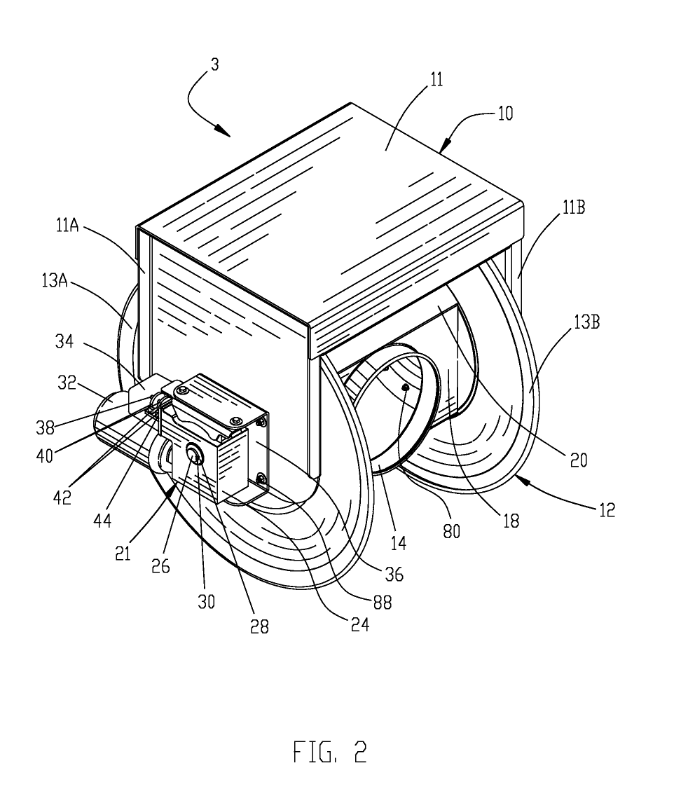

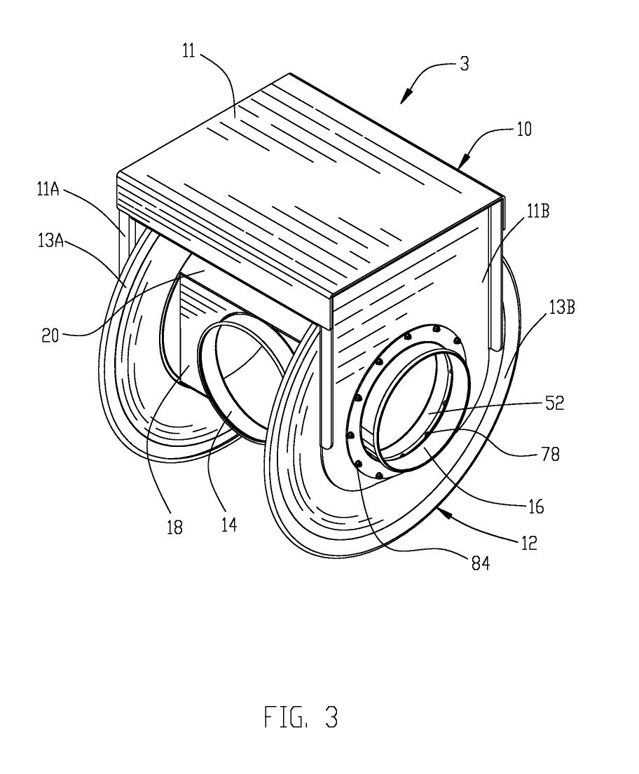

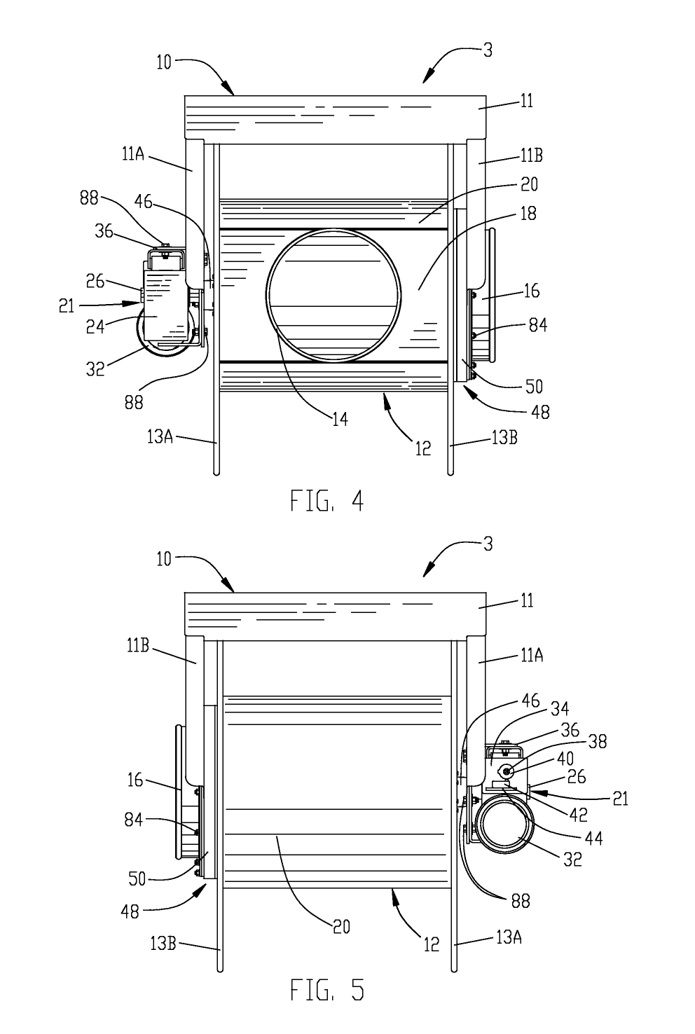

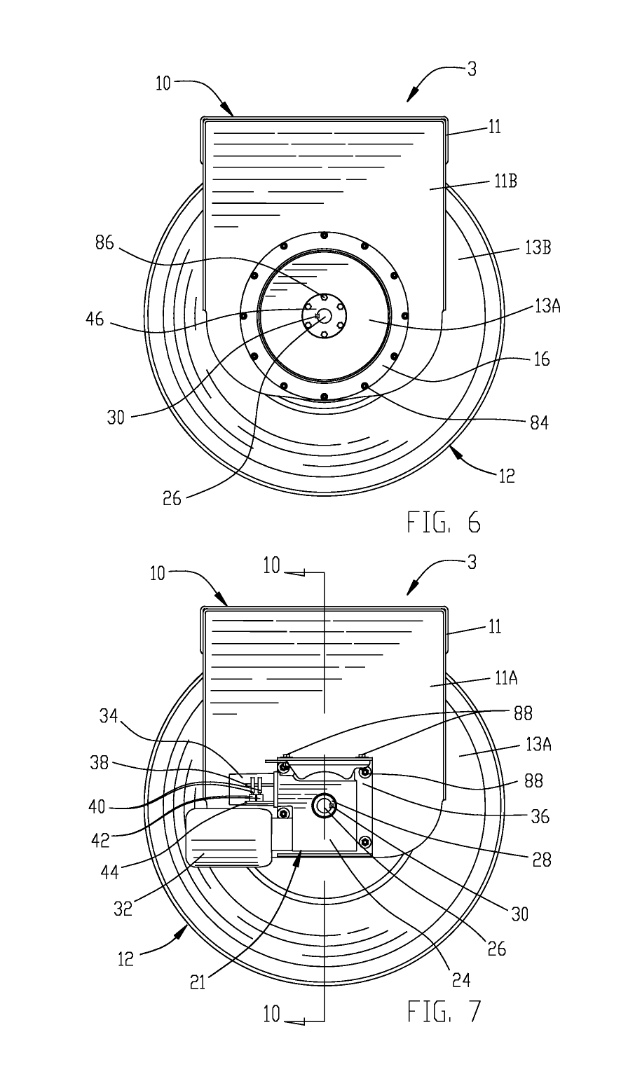

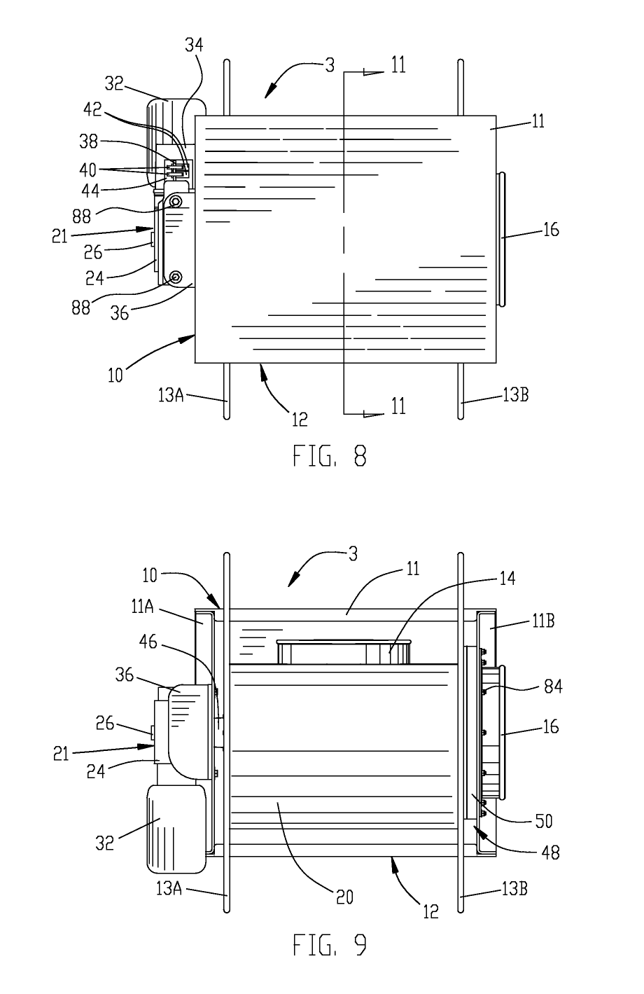

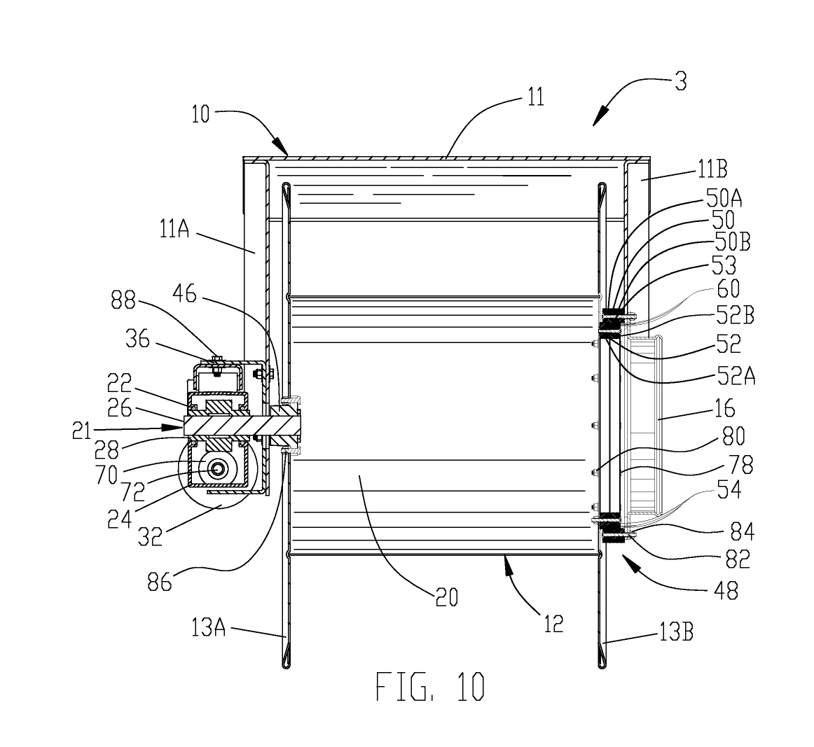

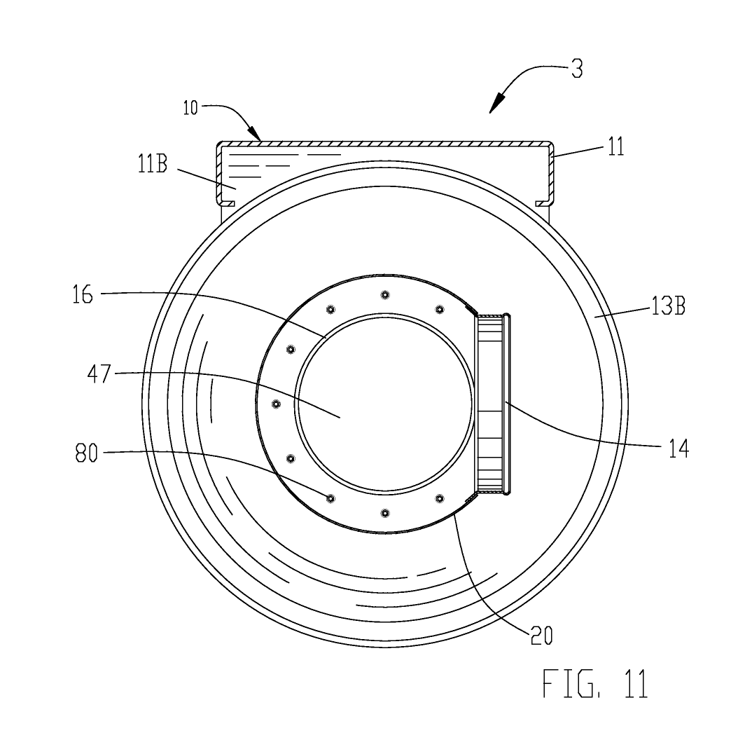

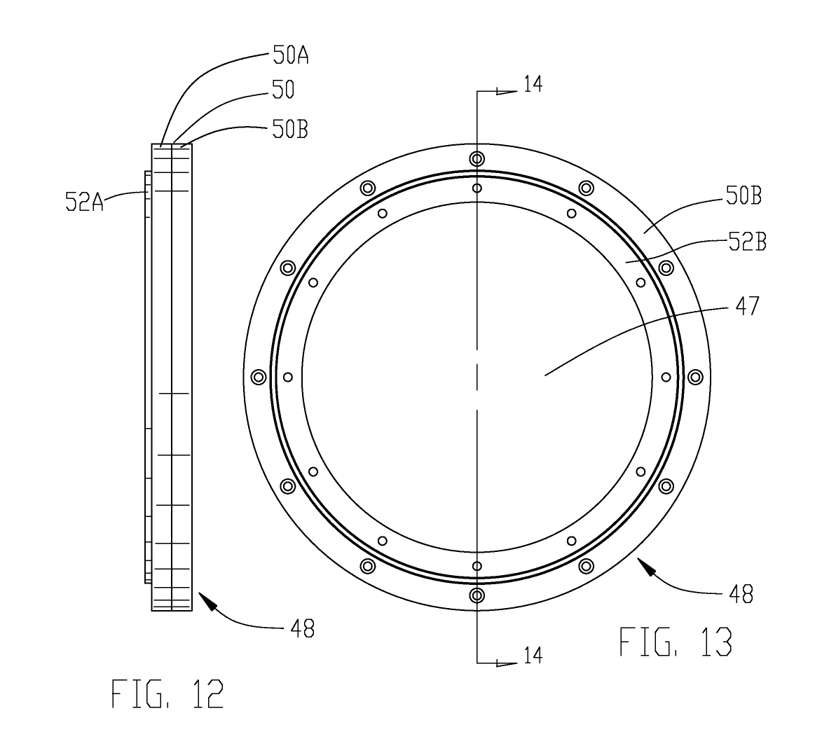

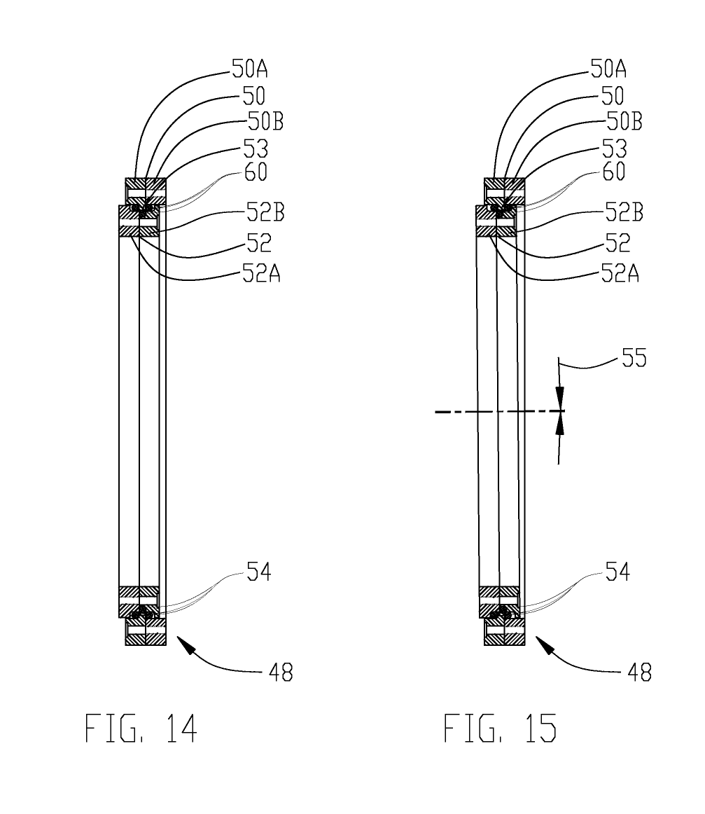

Referring now to the drawings, and particularly to FIGS. 2-11, there is shown a duct reel apparatus generally designated 3 including a generally U shaped mounting frame assembly 10 having an upper frame 11 and axially spaced, first and second, generally parallel side frames 11A, 11B, supporting a plenum reel assembly 12 and gear drive assembly 21. Plenum reel assembly 12 includes axially spaced, annular side flanges, 13A, 13B fixedly joined to axial opposite ends of plenum reel outlet flange 18 and plenum reel wrapper 20, and having a longitudinal axis defining an axis of rotation about the centerline of drive shaft 26 and air inlet polymer rotary swivel assembly 48. Plenum reel outlet flange 18 having air duct outlet adaptor 14 for the connecting of the pre conditioned air duct 5 allowing for an air outlet means of the plenum reel assembly 12. Side flange 13A having a drive shaft hub 46 fixedly mounted about the flange center axis by a plurality of hub bolts 86 supporting a first end of drive shaft 26, a second end of drive shaft 26 being supported by gear drive hollow shaft 28, the first and second ends of drive shaft 26 being rotatably fixed by drive shaft key 30.

A reversible electric gear drive assembly 21 is fixedly attached to side frame 11A and gear drive mount bracket 36 by mount bolts 88 attached to gear drive housing 24. As electrical power is applied to drive motor 32, motor shaft 72 fixedly connected to worm gear 70 rotate gear drive hollow shaft 28 rotatably mounted within gear drive bearings 22 and fixedly attached to drive shaft 26. The axis of rotation of drive shaft 26 is coextensive with the axis of rotation of plenum reel assembly 12. A first and second limit switch cam 40 is rotatably adjustable about the center of limit switch rotary shaft 38 to actuate a corresponding first and second limit switch 42 fixedly attached to limit switch mount 44, mounted internal to limit switch cover 34. Limit switch rotary shaft 38 drivenly connected to the axis of rotation of plenum reel assembly 12 at a fixed ratio allowing the plenum reel assembly 12 to rotate the number of times to retract or deploy the length of pre conditioned air ducting 5 before limit switch rotary shaft 38 revolves one time causing limit switch cam 40 to actuate limit switch 42 and de-energizes the motor. Limit switches 42 being electrically connected to an external control means (not shown), a first limit switch cam 40 is adjusted to actuate a first limit switch 42 for controlling the number of revolutions of plenum reel assembly 12 in a first direction, a second limit switch cam 40 is adjusted to actuate a second limit switch 42 for controlling the number of revolutions of plenum reel assembly 12 in an opposite direction to prevent over winding or unwinding of the pre conditioned air ducting 5 as the duct is retracted or deployed to aircraft 1. As the motor is energized to rotate the plenum reel assembly 12 in a retracting or winding direction the duct is pulled across the ground or airport tarmac and is collapsed to a flat state as it is wound about the reel until the length is fully retracted and limit switch 42 de-energizes the motor. If the motor is energized to rotate the plenum reel assembly 12 in the opposite angular direction, the duct is deployed or unwound from the reel until the corresponding limit switch 42 de-energizes the motor.

Air inlet polymer rotary swivel assembly 48 has an external race 50 disposed radially around internal race 52 radially connected by polymer bearing rods 60 being mounted in circumferential spaced apart internal race grooves 54 formed on the outwardly facing radial surface of the internal race 52, the outer diameter of polymer bearing rods 60 being rotatably engaged with the inwardly facing radial surface of the external race 50, the external race 50 having an inwardly extending circumferential external race spline 53 axially engaged between spaced apart polymer bearing rods 60 being mounted in circumferential spaced apart internal race grooves 54. Internal race grooves 54 having a width that is wider than the corresponding polymer bearing rods 60 to allow the rotating internal race 52 to have an axial misalignment angle 55 with respect to the fixedly mounted external race 50. Polymer bearing rods 60 consisting of an engineered polymer material to minimize friction and allow external race 50 to rotate freely about the internal race 52. External race 50 is a two piece assembly consisting of an external inner race 50A and an external outer race 50B, the external inner race 50A and the external outer race 50B consisting of an engineered polymer such as grease impregnated nylon to minimize friction. Internal race 52 is a two piece assembly consisting of an internal inner race 52A and an internal outer race 52B, the internal inner race 52A and the internal outer race 52B consisting of an engineered polymer such as grease impregnated nylon to minimize friction. Internal race 52 is fixedly mounted to side flange 13B by a number of inner race bolts 78 and inner race nuts 80, side flange 13B having an opening corresponding to internal race 52 internal diameter to allow pre conditioned air to flow freely into plenum reel assembly 12. External race 50 is fixedly mounted to side frame 11B and air duct inlet adaptor 16 with a number of outer race bolts 82 and outer race nuts 84, side frame 11B and air duct inlet adaptor 16 having an opening corresponding to the external race 50 internal diameter to allow pre conditioned air to flow freely into the plenum reel assembly 12 from an external air conditioning apparatus (not shown) connected to air duct inlet adaptor 16. Due to the provision of the air inlet polymer rotary swivel assembly 48 the air inlet at the air inlet duct adaptor is not rotated while remaining in pressurized communication with the plenum reel assembly 12 as it is rotated in a deploying or retracting direction. Plenum reel assembly 12 comprising an internal air chamber directing air flow from a fixed air duct inlet adaptor 16 to a rotatable air duct outlet adaptor 14, and an external surface for the winding and storage of pre conditioned air ducting 5 when not required for providing pre conditioned air to waiting aircraft 1.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. An air duct storage and deployment apparatus comprising:
a plenum reel rotatably mounted in a frame;
an electric drive assembly engaged with and selectively rotatably driving said plenum reel;
an air duct being selectively rotatably wound and stored on said reel and rotatably unwound and deployed from said reel; and,
a polymer rotary swivel assembly rotatably connecting said plenum reel to said frame and an external pre-conditioned air source, said polymer rotary swivel having an external polymer race disposed radially about an internal polymer race, said internal polymer race having a plurality of circumferential grooves disposed inwardly from the outward facing radial surface of said internal polymer race, a plurality of polymer bearing rods circumferentially disposed within said circumferential grooves, said external polymer race having an inwardly extending circumferential spline from the inward facing radial surface of said external polymer race and disposed between said polymer bearing rods.

2. The apparatus of claim 1 wherein said polymer rotary swivel internal polymer race comprises an internal hollow diameter of between 4 and 14 inches.

3. The apparatus of claim 2 wherein said external polymer race is comprised of two components.

4. The apparatus of claim 2 wherein said internal polymer race is comprised of two components.

5. The apparatus of claim 2 wherein said external polymer race is comprised of a single component.

6. The apparatus of claim 2 wherein said external polymer race comprises two or more inwardly extending circumferential splines.

7. The apparatus of claim 2 wherein the cross section of said polymer bearing rods is substantially circular.

8. The apparatus of claim 7 wherein said internal polymer race circumferential grooves are wider than said polymer bearing rods disposed therein, allowing said internal polymer race to rotate freely while in axial misalignment with said external polymer race.

9. The apparatus of claim 2 wherein the cross section of said polymer bearing rods is substantially rectangular.

10. The apparatus of claim 2 wherein said internal polymer race and said external polymer race comprise a self lubricating polymer with a coefficient of friction value <0.20.

11. The apparatus of claim 2 wherein said polymer bearing rod comprise a self lubricating polymer with a coefficient of friction value <0.15.

12. An air duct storage and deployment apparatus comprising:
a plenum reel rotatably mounted in a frame;
an electric drive assembly engaged with and selectively rotatably driving said plenum reel;
an air duct being selectively rotatably wound and stored on said reel and rotatably unwound and deployed from said reel; and,
a polymer rotary swivel assembly rotatably connecting said plenum reel to said frame and an external pre-conditioned air source, said polymer rotary swivel having an external polymer race disposed radially about an internal polymer race, said external polymer race having a plurality of circumferential grooves disposed outwardly from the inward facing radial surface of said external polymer race, a plurality of polymer bearing rods circumferentially disposed within said circumferential grooves, said internal polymer race having an outwardly extending circumferential spline from the outward facing radial surface of said internal polymer race and disposed between said polymer bearing rods.

13. The apparatus of claim 12 wherein said polymer rotary swivel internal polymer race comprises an internal hollow diameter of between 4 and 14 inches.

14. The apparatus of claim 13 wherein said external polymer race is comprised of two components.

15. The apparatus of claim 13 wherein said internal polymer race is comprised of two components.

16. The apparatus of claim 13 wherein said internal polymer race is comprised of a single component.

17. The apparatus of claim 13 wherein said internal polymer race comprises two or more outwardly extending circumferential splines.

18. The apparatus of claim 13 wherein the cross section of said polymer bearing rods is substantially circular.

19. The apparatus of claim 18 wherein said external polymer race circumferential grooves are wider than said polymer bearing rods disposed therein, allowing said internal polymer race to rotate freely while in axial misalignment with said external polymer race.

20. The apparatus of claim 13 wherein the cross section of said polymer bearing rods is substantially rectangular.

21. The apparatus of claim 13 wherein said internal polymer race and said external polymer race comprise a self lubricating polymer with a coefficient of friction value <0.20.

22. The apparatus of claim 13 wherein said polymer bearing rod comprise a self lubricating polymer with a coefficient of friction value <0.15.
